(19) United States
(12) Patent Application Publication
(10) Pub. No.: US 2016/0276787 A1
(43) Pub. Date: Sep. 22, 2016

(54) RECEPTACLE ASSEMBLY OF NEMA PLUGS

(71) Applicant: SPANTIK, S.A., Panama (PA)

(72) Inventor: Vicente González González, Caracas (VE)

(73) Assignee: SPANTIK, S.A., Panama (PA)

(21) Appl. No.: 14/955,719

(22) Filed: Dec. 1, 2015

(30) Foreign Application Priority Data
Mar. 19, 2015 (MX) MX/U/2015/000151

(51) Int. Cl. H01R 24/30; H01R 25/00

(52) U.S. Cl. CPC H01R 24/30; H01R 25/006; H01R 2107/00

(57) ABSTRACT

A receptacle assembly for NEMA plugs, comprising: a first pair of wires that run parallel to each other with a gap wide enough to form a first retention area; a second pair of wires that run parallel to each other with a gap wide enough to form a second retention area; a front face that includes two rows of fastening devices with two slots in each fastening device; wherein each wire in the first and second pair of wires is inserted into one of the slots of the fastening device of the front face, so that the first and second retention areas can receive a flat blade of the NEMA plug.

### BACKGROUND OF THE INVENTION

Duly embossed and folded bronze or brass plates are generally used in the manufacture of NEMA 1-15 and/or 5-15 plugs receptacles in order to achieve electrical connection and retention with the plug blades. Since the plug blades have different shapes and dimensions, specific metalwork designs are needed to connect each plug blade.

The widths of two of the flat blades in the NEMA 1-15 plug can be different in order to polarize them and guarantee their correct insertion, phase and neutral. This is another limitation or difficulty for the current technique to overcome, as the differential must be considered in the receptacle design.

For manufacturing multiple outlets, the metalwork must conduct the power among such outlets as well as comply with the standards of electrical retention and contact. The plates used in the manufacture of this metalwork must be embossed and folded to present the retention contacts along the different receptacles.

This invention proposes using rigid, circular cross-sectioned wires to simplify the manufacture of plug receptacles, with the advantage of eliminating the waste generated by the embossing procedure.

A second advantage of this invention is that it facilitates the insertion and disconnection of the plug blades.

A third advantage of this invention is that the circular cross-section of the wires allows to insert and disconnect the plugs with minor wear.

The characteristics of this invention are explained in the following description and the figures attached.

### DESCRIPTION OF THE DRAWINGS

FIG. 1 is a sectional view of the invention wiring adapted to receive a NEMA 1-15 plug, excluding other elements of the invention to facilitate viewing the insertion of blades 5 and 6 into the A and B retention zones.

FIG. 2 is a perspective view of FIG. 1 assembly.

FIG. 3 is a sectional view of the invention wiring adapted to receive a NEMA 5-15 plug, excluding other elements of the invention to facilitate viewing the insertion of blades 5′, 6′, and 7′ into the A, B, and C retention zones.

FIG. 4 is a perspective view of FIG. 3 assembly.

FIG. 5 is a perspective view of the front face of the receptacle assembly according to the invention.

FIG. 6 is a sectional view of the front face of FIG. 5.

FIG. 7 is a perspective view of the back body of the receptacle assembly according to the invention. For reference purposes, this Figure includes the same wiring used to describe FIG. 5 according to the invention.

FIG. 8 is a sectional view of the back body in FIG. 7.

FIG. 9 is a perspective view of a receptacle according to the invention before connecting the front face and the back body and showing the inner wiring.

FIG. 10 is a perspective view of a receptacle according to the invention with the front face and back body in the receptacle assembly in their final assembly position.

FIG. 11 is a possible embodiment of the front face of the invention assembly, which presents two NEMA 5-15 plugs for reference purposes.

FIG. 12 is a possible embodiment of the front face of the invention assembly, which presents seven NEMA 5-15 plugs for reference purposes.

### DESCRIPTION OF THE INVENTION

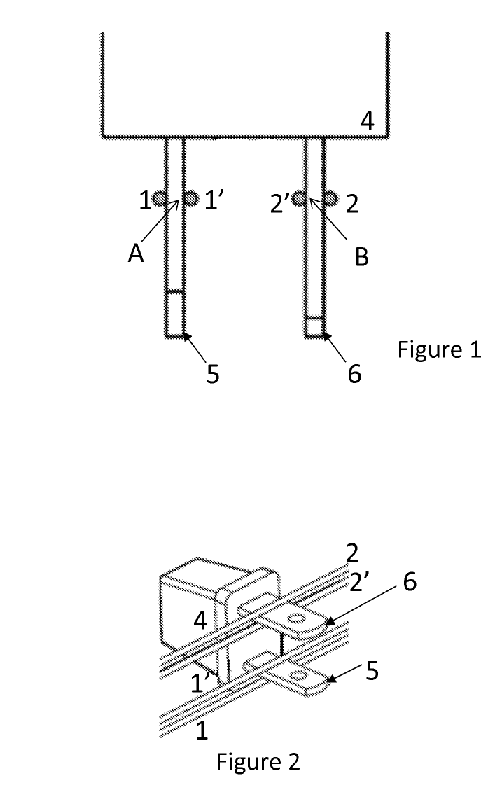

As seen in the possible embodiment of the invention adapted to receive a NEMA 1-15 plug (polarized or non-polarized) shown in FIG. 1, the receptacle includes four straight wires that run parallel to each other. The wires have a circular cross-section and are manufactured with a material that facilitates or permits electrical conductivity. The wires are preferably made of copper or copper alloys, like brass or bronze. The tension required to ensure retention of the plugs during powering with a power strip, outlet, or the like, including the invention receptacle while facilitating the insertion and disconnection of the NEMA (1-15 and/or 5-15) plug blades, is achieved through the elastic properties of the wire, which in this case is made of copper, brass, bronze, or a similar alloy. The hardness degree of the wire material must preferably be from HALF-HARD to HARD. As an option, the wires may be nickel- or tin plated to extend their durability in moist or corrosive environments.

In FIG. 1 assembly, the wires were set up to form two retention areas for the flat blades of the NEMA 1-15 plug (polarized or non-polarized) once the plug is inserted into the power strip or outlet that receives the invention receptacle. Each area is limited by a pair of wires that run parallel to each other. The first retention area A is limited by a first pair of wires 1 and 1′. The second retention area B is limited by a second pair of wires 2 and 2′. When the plug is connected to a receptacle of the invention, blades 5 and 6 of plug 4 are inserted into retention areas A and B, respectively. FIG. 2 shows a perspective view of FIG. 1 assembly.

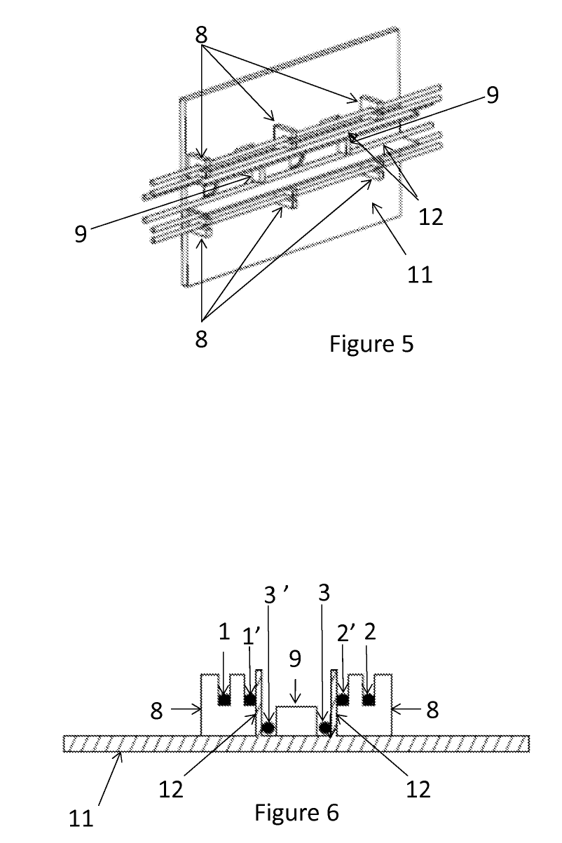

The pairs of wires 1-1′ and 2-2′ are separated by a gap that allows the insertion of blades 5 and 6 of plug 4 into retention areas A and B. This gap is equal to or slightly smaller than the width of blades 5 and 6. In general, the gap between the pairs of wires 1-1′ and 2-2′ ranges from 1.0 mm to 1.65 mm. The gap between the pairs of wires 1-1′ and 2-2′ should preferable measure 1.2 mm to 1.65 mm. This gap is wide enough to allow the insertion of the NEMA 1-15 plug blades and ensure their retention because of elements 8 (see FIG. 5), which fixate the wires on both sides and to a certain distance of the blade insertion area.

The round profile of the wires facilitates the insertion and disconnection of the NEMA (1-15 and/or 5-15) plug blades while simultaneously ensuring adequate contact for the correct power transmission between blades 5 and 6 and the first pair of wires 1 and 1′, and the second pair of wires 2 and 2′.

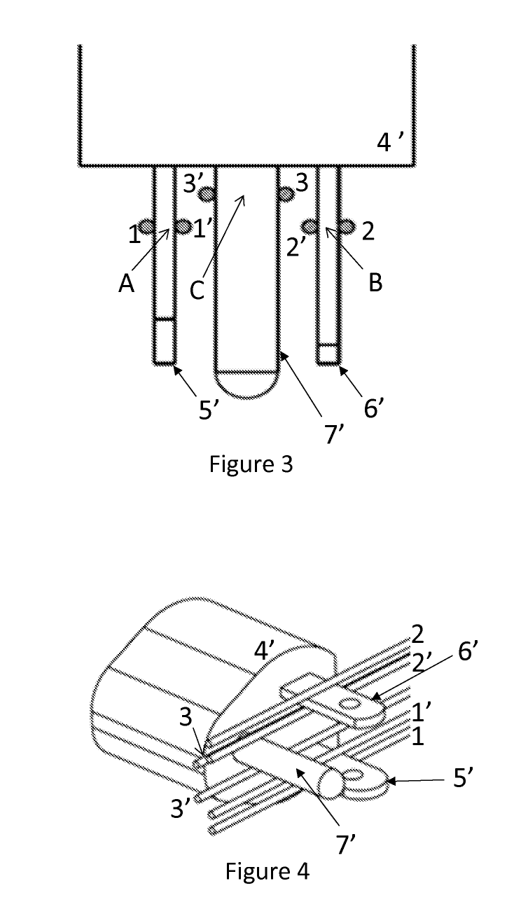

FIG. 3 shows a possible embodiment of the invention receptacle adapted to NEMA 5-15 plugs. This figure shows a third pair of wires 3 and 3′ placed between the first pair of wires 1 and 1′ and the second pair of wires 2 and 2′. The shape (circular cross-section) and materials of wires 3 and 3′ meet the specifications of wires 1 and 1′, and 2 and 2′ described above. FIG. 3 wires were set up to form three retention areas for the NEMA 5-15 plug blades. Each area is limited by a pair of wires that run parallel to each other. The first retention area A is limited by a first pair of wires 1 and 1′;the second retention area B is limited by a second pair of wires 2 and 2′; and the third retention area C is limited by a third pair of wires 3 and 3′. Blades 5′, 6′, and 7′ of plug 4 are inserted into the A, B, and C retention zones, respectively.

FIG. 4 shows a perspective view of FIG. 3 assembly. The 1-1′ and 2-2′ wire pairs are separated by a gap similar to the gap described above for the embodiment of FIG. 1. Likewise, the gap between the wires 3 and 3′ allows inserting the central blade 7′ of the NEMA 5-15 plug into retention area C. This gap is equal to or slightly smaller than the width of blade 7′. In general, the gap between the pairs of wires 3-3′ ranges between 4.0 mm and 4.83 mm, though the gap between the pairs of wires 3-3′ should preferably range between 4.17 mm and 4.83 mm. The round profile of the wires facilitates the insertion and disconnection of the NEMA (1-15 and/or 5-15) plug blades, thus constantly ensuring the adequate contact for a correct power transmission between blades 5′, 6′, and 7′ and the wires 1 and 1′, 2 and 2′, and 3 and 3′, respectively.

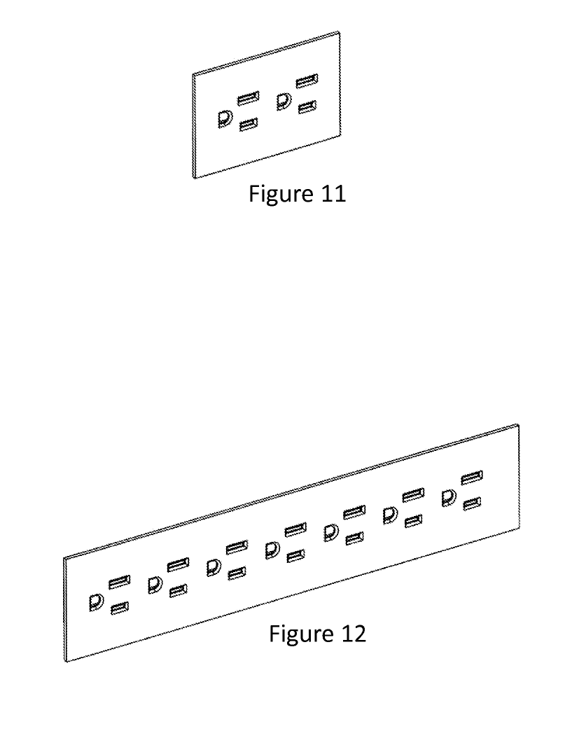

The invention receptacle also includes structures inside the power strip, outlet, or the like (hereinafter referred to as “outlet set” to facilitate description) that help fix the wires 1, 1′, 2, 2′, 3, and 3′ while allowing such wires to bend when they receive a plug blade and return to their original form when the blade is removed. As a reference, FIGS. 5 and 6 show the fastening device of the front face 11 of the receptacle assembly 10. In this case, the front face 11 includes two power outlets, and the fastening devices are represented by two rows that include three fastening devices 8 per row. The minimum requirement of fastening devices 8 is two per each outlet. The number of fastening devices 8 required to manufacture a power strip with a determined number n of outlets corresponds to 2n+2. For example, for the embodiment of FIG. 11, the invention assembly should include six fastening elements 8 (three in each row as shown in FIG. 5); for the embodiment shown in FIG. 12, the assembly should include sixteen fastening elements 8 (eight in each row). Likewise, the front face 11 includes central fastening elements 9. As seen in FIGS. 5 and 6, wires 1, 1′, 2, and 2′ will be fixed into one of the two slots inside the fastening element 8, thus avoiding contact between each of the wires 1-1′ and 2-2′. 3-3′ wires are fixed and separated from each other by the central fastening elements 9. The power outlet set may have a minimum of one central fastening element 9 between the 3 and 3′ wires. However, more elements 9 can be added depending on the length of the outlet set. Elements 9 are preferably placed evenly apart from blade 7′ and two are used for each power outlet. The physical gap between the 1′-3′ and 3-2′ wires is secured by two extensions 12 of the front face 11, which can be extended along the body of element 11 (as shown in FIG. 5) or discontinuously in one or several sections along the front face 11.

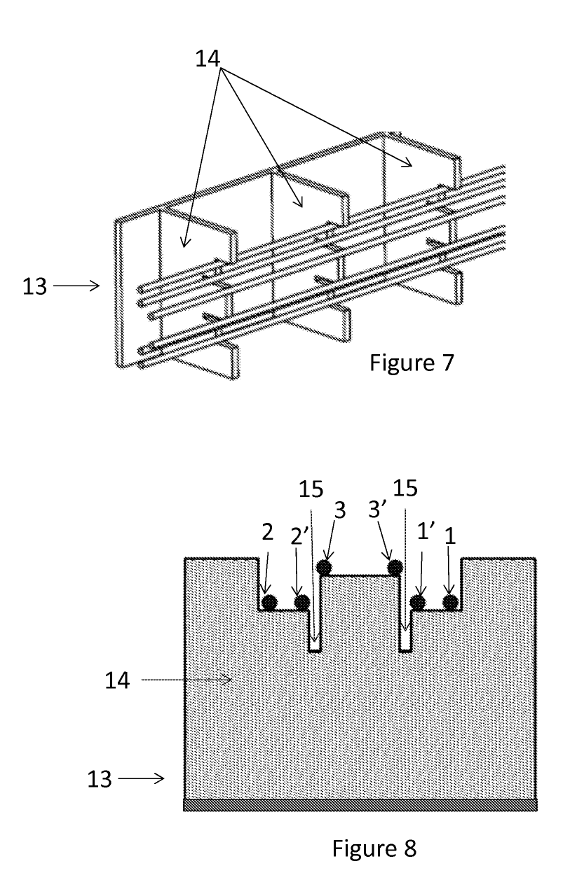

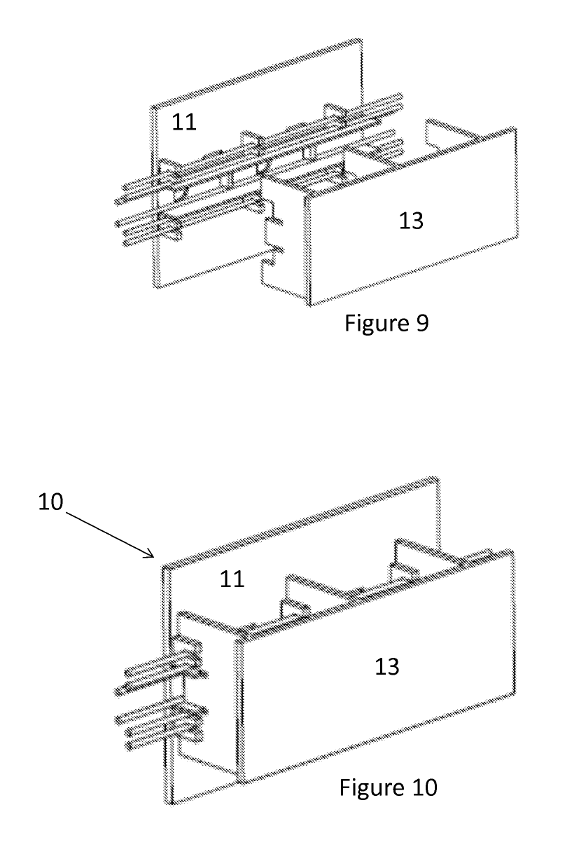

The invention can additionally include fastening devices as shown in FIG. 7. These fastening devices are represented by three extensions 14 of the back body 13 of the receptacle assembly 10. FIG. 8 shows a sectional view of element 13 of FIG. 7. When included, the fastening devices 14 are additional to the fastening devices 8 and 9 of the front face 11. Fastening devices 14 include two slots 15 with the appropriate shape and dimensions to receive extensions 12 of the front face 11.

In order to power the device, power strip, extension, or device joined or connected to a type 4 plug in FIG. 1 or type 4′ in FIG. 3, wires 1, 1′, 2, 2′, 3, and 3′ must be connected directly to a power source. For example, in case the invention is installed in a wall outlet, the power source includes the internal connections that supply current to the rest of the home. In case the invention is installed inside a power strip, the power will be supplied by an external source where the strip is connected; for example, a power outlet that includes or does not include a receptacle of this invention. Regardless of the device, power strips, outlets, or the like, where the present invention receptacle is installed, the wires will be fixed to their positions inside said device using insulating materials like plastic or insulating resins.

This description is intended to present the invention with reference purposes and should in no way be construed so as to limit or restrict the claimed invention. Likewise, the drawings presented are referential representations to clarify the principles supporting the invention and the contributions regarding the technique status.

1. A receptacle assembly for NEMA plugs, comprising:
a first pair of wires that run parallel to each other with a gap wide enough to form a first retention area;
a second pair of wires that run parallel to each other with a gap wide enough to form a second retention area;
a front face that includes two rows of fastening devices with two slots in each fastening device;
wherein each wire in the first and second pair of wires is inserted into one of the slots of the fastening device of the front face, so that the first and second retention areas can receive a flat blade of the NEMA plug.

2. An assembly as recited in claim 1, wherein the number of fastening devices 8 equals 2n+2, n being the number of outlets included in the set.

3. An assembly as recited in claim 2, comprising a gap between the wires in the first pair of wires and a gap between the wires in the second pair of wires that range from 1.00 mm to 1.65 mm.

4. An assembly as recited in claim 3, comprising a gap between the wires in the first pair of wires and a gap between the wires in the second pair of wires that range from 1.2 mm to 1.65 mm.

5. An assembly as recited in claim 4, comprising a third pair of wires that run parallel to each other with a gap wide enough to form a third retention area, wherein said third pair of wires is placed between the first and the second pair of wires.

6. An assembly as recited in claim 5, comprising a front face with additional central fastening devices between the wires in the third pair of wires.

7. An assembly as recited in claim 6, comprising a gap between he wires in the third pair of wires that ranges from 4.00 mm to 4.83 mm.

8. An assembly as recited in claim 7, comprising a gap between the wires in the third pair of wires that ranges from 4.17 mm to 4.83 mm.

9. An assembly as recited in claim 8, comprising wires made of copper or copper alloys, like brass or bronze, or a similar alloy.

10. An assembly as recited in claim 9, comprising wire materials with a hardness degree that ranges from HALF-HARD to HARD.

11. An assembly as recited in claim 10, comprising nickel- or tin plated wires.
